(19) United States
(12) Patent Application Publication
(10) Pub. No.: US 2015/0363738 A1
(43) Pub. Date: Dec. 17, 2015

(54) SYSTEM FOR REMOTELY MONITORING WELL SITES

(71) Applicant: QUADRUM ENERGY LLC, Houston, TX (US)

(72) Inventor: MARC HACI, HOUSTON, TX (US)

(73) Assignee: QUADRUM ENERGY LLC, Houston, TX (US)

(21) Appl. No.: 14/737,518

(22) Filed: Jun. 12, 2015

Related U.S. Application Data
(60) Provisional application No. 62/011,156, filed on Jun. 12, 2014.

(51) Int. Cl. G06Q 10/06

(52) U.S. Cl. CPC G06Q 10/063114

(57) ABSTRACT

An automated system for remotely monitoring, location mapping, and transmitting to at least one client device via a network, maps, asset information, and personnel information on assets and personnel within a geographically defined perimeter of at least one well site including information on movement of those assets and personnel. The system comprises at least one access tower positioned at each well site for remotely monitoring within the geographically defined perimeter, a plurality of perimeter sensors connected to an alarm system that arms and disarms alarms for the geographically defined perimeter, at least one recording device, a well site processor, a well site data storage, and an administrative processor with an administrative data storage connected to a network for receiving an executive dashboard.

### RELATED APPLICATION

This application is related to and claims priority from U.S. Provisional Application No. 62/011,156 entitled “System for Remotely Monitoring a Well Site” filed on Jun. 12, 2014, which is expressly incorporated by reference herein.

### FIELD

The present embodiments generally relate to a system for remotely monitoring a geographically defined perimeter and its contents for a well site.

### BACKGROUND

Hydrocarbon well sites are generally located at remote rural locations which are difficult to visit and often left unattended for periods of time while some equipment is operating. Hydrocarbon well sites often include drilling, pumping and other equipment having moving parts which operate under very high pressures. Only certified and highly trained personnel are required to work in a well site.

Due to mechanical errors or human errors or simply whether conditions, catastrophes such as spills, fires or even explosions can occur in a well site. Consequently, rural well sites are dangerous places, and any uncertified untrained personnel, domestic animals and wild life must be prevented from entering the well site. Since many of these locations are far from security networks, they are also prone to a high risk of theft activity which causes loss of income and down time of the well because of damage to equipment from vandalism or theft of critical equipment. This can further increase the insurance premiums paid by the operating company. The latest available data dated Jan. 7, 2011 released by US Energy Information Administration (EIA) shows that there are 363,459 Oil and 461,388 Gas wells in the United States. The security of these remote well locations is an immense problem and can only be achieved with universal, easy to install and self-contained systems.

Therefore, a need exists for a system that simultaneously monitors personnel and assets, arms and disarms a perimeter of a hydrocarbon well site and transmits information concerning the activities within the well site, the arming and disarming to an account with an executive dashboard that can be viewed from one of a plurality of client devices.

### SUMMARY

An aspect of the present invention, an automated system for remotely monitoring, location mapping, and transmitting to at least one client device via a network, maps, asset information, operational and personnel information on assets including information on at least one hydrocarbon well and personnel within a geographically defined perimeter of at least one well site including information on movement of those assets and personnel, comprises: a plurality of operating sensors disposed adjacent the at least one hydrocarbon well and configured to detect and transmit operating data of each hydrocarbon well; at least one access tower positioned at each well site for remotely monitoring within the geographically defined perimeter, each access tower comprising: an access tower identifier, an alarm system for arming and disarming alarms for the geographically defined perimeter, a power supply mounted to the access tower, a tower transceiver connected to the power supply, a well site processor mounted to the access tower and in communication with the tower transceiver and electrically connected to the power supply, a plurality of perimeter sensors, in communication with the well site processor, mounted to the access tower and configured to detect and transmit locations of assets and personnel, the plurality of perimeter sensors being connected to the power supply and the alarm system for arming and disarming alarms for the geographically defined perimeter, a well site data storage, including non-transitory computer readable medium, in communication with the well site processor, the well site storage being configured to receive the locations of personnel and assets from the plurality of perimeter sensors as well as the operating data of each hydrocarbon well from the plurality of operating sensors, wherein the well site data storage is configured to form a tracking map and an executive dashboard including the tracking map showing the locations of personnel and assets as well as the operating data of each hydrocarbon well from the plurality of operating sensors, and at least one recording device mounted to the access tower and electrically connected to the power supply for creating at least one of videos, infrared images, and audio signals for personnel and assets within the geographically defined perimeter for each well site; an administrative processor connected, via the network, to both the transceiver at each access tower and at least one client device for remotely monitoring each well site; and an administrative data storage, including non-transitory computer readable medium, in communication with the administrative processor for receiving the executive dashboard with the tracking map from the well site data storage, the administrative data storage comprising an account identifier with the hydrocarbon well identifier, contact information, personnel data for each hydrocarbon well identifier, and asset data for each hydrocarbon well identifier.

Another aspect of the present invention, a method of remotely monitoring a hydrocarbon well site having a geographically defined perimeter, comprises: creating an administrative data in an administrative data storage to the hydrocarbon well site, the administrative data storage includes non-transitory computer readable medium, comprising: assigning personal identifications to authorized persons, the authorized persons being permitted to access to the hydrocarbon well site, associating each authorized person to a selected work location at the hydrocarbon well site, assigning asset identifications to identified assets at the hydrocarbon well site, the identified assets including authorized vehicles permitted to access to the hydrocarbon well site and at least one hydrocarbon well located at the hydrocarbon well site, and identifying operation parameters associated with at least one hydrocarbon well located at the hydrocarbon well site; identifying an access tower within the hydrocarbon well site; continuously capturing a video and audio recording of the hydrocarbon well site using a camera recorder mounted to the access tower; receiving in real time a first sensed data from a first set of sensors mounted on the access tower, the first sensed data from the first set of sensors including locations of the authorized persons within the hydrocarbon well site and locations of the authorized vehicles within the hydrocarbon well site; receiving in real time a second sensed data from a second set of sensors located at each hydrocarbon well, the second sensed data including identification of each hydrocarbon well and the operational data associated with each hydrocarbon well, wherein the operational data include data associated with a plurality of operational measurement generated by control devices of each hydrocarbon well; storing a well site data record of the hydrocarbon well site in a well site data storage located at the access tower, the well site data record including the first sensed data and the second sensed data, wherein the well site data storage includes non-transitory computer readable medium; forming an electronic map of the hydrocarbon well site using the well site record and mapping the locations of the authorized persons on the electronic map of the hydrocarbon well site; and electronically communicating the electronic map as well as the video and audio recording of the well site to a monitoring location remote to the hydrocarbon well site so as to remotely monitor the well site.

Yet another aspect of the present invention, a method of monitoring a hydrocarbon well site having a geographically defined perimeter, the well site including at least one hydrocarbon well unit, comprises: transporting at least one access tower to the well site, each access tower being transported as a kit wherein each kit includes a tower base, a tower support and a tower housing including a plurality of motion sensors connected to an access tower module; assembling each access tower by attaching the tower housing to a first end of the tower support and by attaching the base to a second end of the support, and anchoring the base to the ground within the well site; adjusting, using a plurality of laser beams as guide, direction and effective distance of the plurality of motion sensors of each access tower to form a monitored area covering the well site, wherein each motion sensor is activated when a motion is detected within the motion sensor's effective distance; recording direction and effective distance of each motion sensor on each access tower to prepare a replacement access tower to replace a malfunctioning access tower quickly; connecting each motion sensor to an alarm system in each module, each alarm system being configured to arm and disarm the monitored area, wherein alarm system is activated when one of the motion sensors are activated on the access tower; and connecting each access tower module to a remote monitoring station to remotely monitor the well site.

### BRIEF DESCRIPTION OF THE DRAWINGS

The detailed description will be better understood in conjunction with the accompanying drawings as follows:

FIG. 1A depicts an overview showing multiple well sites monitored by an embodiment of a monitoring system of the present invention;

FIG. 1B depicts an embodiment of an access tower of the present invention;

FIG. 1C depicts a top view of a tower housing of the access tower shown in FIG. 1B;

FIG. 1D depicts an exemplary well site surrounded by a geographically defined perimeter, wherein the well site has been monitored by the monitoring system of the present invention;

FIG. 2 depicts the administrative processor and administrative data storage;

FIG. 3 depicts the well site processor and well site data storage;

FIG. 4 depicts an executive dashboard created according to an embodiment of the monitoring system; and

FIG. 5 depicts a flow chart showing an embodiment of a process using the monitoring system.

The present embodiments are detailed below with reference to the listed Figures.

### DETAILED DESCRIPTION OF THE EMBODIMENTS

Before explaining the present system and method in detail, it is to be understood that the system and method are not limited to the particular embodiments and that they can be practiced or carried out in various ways. Embodiments of the present invention provides a system for remotely monitoring at least one hydrocarbon well site, within a geographically defined perimeter, using at least one access tower and transmitting collected information on assets, personnel and hydrocarbon well equipment to a remote monitoring station remote to each hydrocarbon well site. The system may use at least one access tower positioned at each hydrocarbon well site for monitoring each hydrocarbon well site within the geographically defined perimeter. Each access tower may be in communication with the remote monitoring station to remotely monitor each well site.

In one embodiment, a transportable access tower may be used for the monitoring system. The access tower may include a top tower housing a support and a base section, which can be easily transported to a remote well site as a kit including these components and quickly assembled at the well site. The tower housing may include a tower module including a processor or controller, a data storage device, a wireless transmitter receiver, a GPS module, alarm system, an audio and video recording device and a plurality of perimeter sensors to monitor moving objects, e.g., personnel and/or vehicle activity within the well site. The access tower may include a power supply such as a solar panel or battery or both to supply power to the module. In one embodiment, the perimeter sensors may be distributed over an outer surface of the tower housing so that the perimeter sensors all together may have a 360 degree monitoring capability around the access tower and form a monitored area fully covering the well site. When the alarm system is armed, if an activity detected within the well site by the perimeter sensors, the alarm system may sound sirens and warning messages about the activity may be sent to the remote monitoring station. When the alarm system is disarmed to allow authorized personnel and authorized vehicles into the well site, the perimeter sensors may monitor the activity of authorized personnel and vehicles and their location and activity may be sent to the remote monitoring station. In another embodiment, in addition to the perimeter sensors, the monitoring system may also be in communication with a plurality of operational sensors disposed at the hydrocarbon well equipment within the well site to monitor the operation of any hydrocarbon production, drilling or pumping equipment, their power sources and other related equipment to determine whether such equipment is working within the preset operational values. If the operational sensors detect an operational value outside the preset values, a malfunction warning may be sent to the remote monitoring station and/or to the authorized personnel within the well site to report the malfunctioning equipment and its location. Based on the report, an attempt to disable the malfunctioning equipment to repair it or an evacuation of the well site may take place for the safety of the personnel. Additionally, the system may be configured to automatically disable the malfunctioning equipment.

A remote monitoring process of the hydrocarbon well site within the geographically defined perimeter may utilize administrative data stored in the administrative data storage of an administrative server, which may include, but not limited to, data related to identifications of authorized personnel, identifications of assets including authorized vehicles and each hydrocarbon well equipment, operation parameters associated with each hydrocarbon well equipment, identifications of each access tower within each well site and preset operational values for each hydrocarbon well equipment.

A well site monitoring data record of the hydrocarbon well site may be in real time stored in the data storage located at the access tower module to be compared and/or authenticated with the data stored in the administrative data storage in real time. The well site monitoring data record may include sensed data from the perimeter sensors and the operational sensors, and any data about the authorized personnel or vehicles, such as their identification, job location and job assignment. The data about the authorized personnel and vehicles may be inputted to the monitoring system before for example disarming the alarm system for a work assignment which may be performed at the well site. An electronic tracking map of the hydrocarbon well site may be formed using the well site monitoring data record showing the locations of the authorized personnel and the authorized vehicles mapped on the electronic tracking map of the hydrocarbon well site. The electronic tracking map, hydrocarbon well equipment operational data as well as the video and audio recording of the well site may be transmitted to the remote monitoring location in real time so as to remotely monitor the well site to allow monitoring personnel to take actions in response to the monitoring data and the tracking map.

The remote monitoring system of the present invention may have many advantages. The invention is expected to prevent human accidents and deaths by preventing uncertified and untrained personnel from walking onto a well site. The invention is expected to prevent harm to domestic animals and wildlife by providing quick detection of their presence at the well site enabling the access tower or personnel near or at the well site to be alerted and take action to distract or shoo off the wildlife. For example, this may be done by sounds, lights or sirens activated by the alarm system or the perimeter sensors to scare and shoo off the animals. The invention is expected to prevent theft at a well site by providing alerts directly to the police through their cell phones, or to private security through cell phone connections to a network for fast arrest and proof of theft. The invention is expected to prevent spills and pollution by preventing untrained and uncertified personnel from entering the site and by monitoring the presence of animals, such as cows, that can rub against valves to turn off or turn on valves causing emissions. The invention is expected to reduce insurance premiums by the operating company by providing access control systems due to increased protection, reducing the possibility of theft. The invention is expected to reduce loss of income and down time of the well by preventing damage to equipment from vandalism or theft of critical equipment. The invention provides for a safer workplace enabling certain safety precautions to be actuated automatically, such as shutting off a pump automatically if a nearby repair must be made.

Once installed on the well site, the access towers may be wirelessly and/or wired connected to each other to form a local network connecting at least two of them to share functions or to function together to operate the perimeter sensors, operational sensors and alarm system, and to coordinate data collection and data storage and to perform monitoring function, transmitting data to remote monitoring stations or to the administrative server.

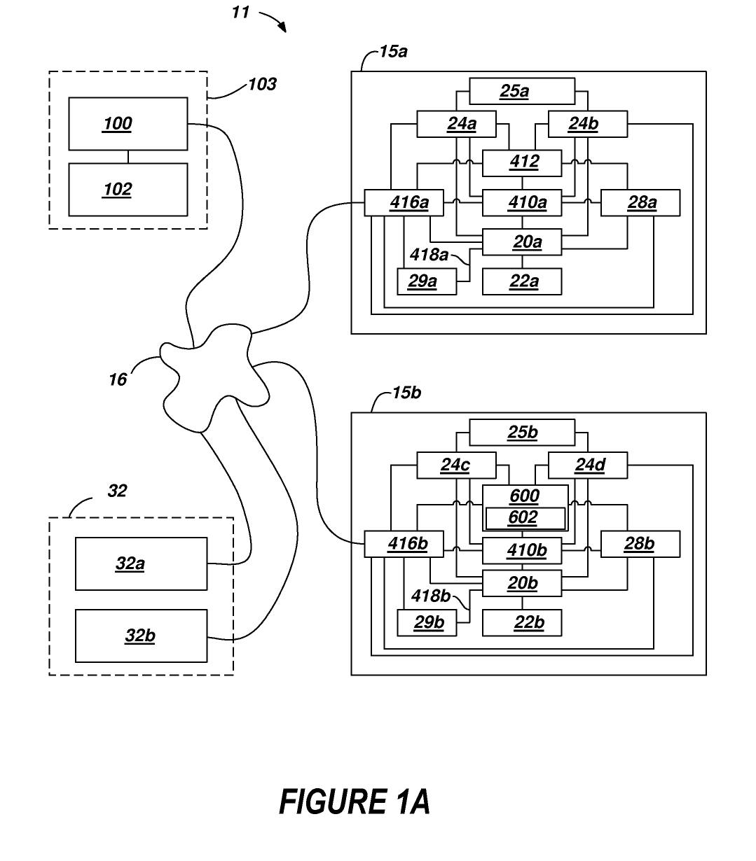

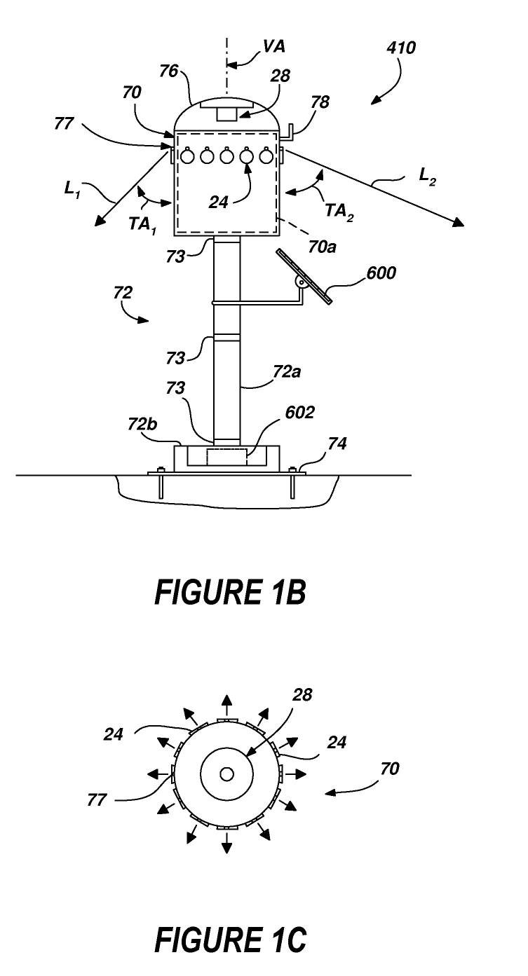

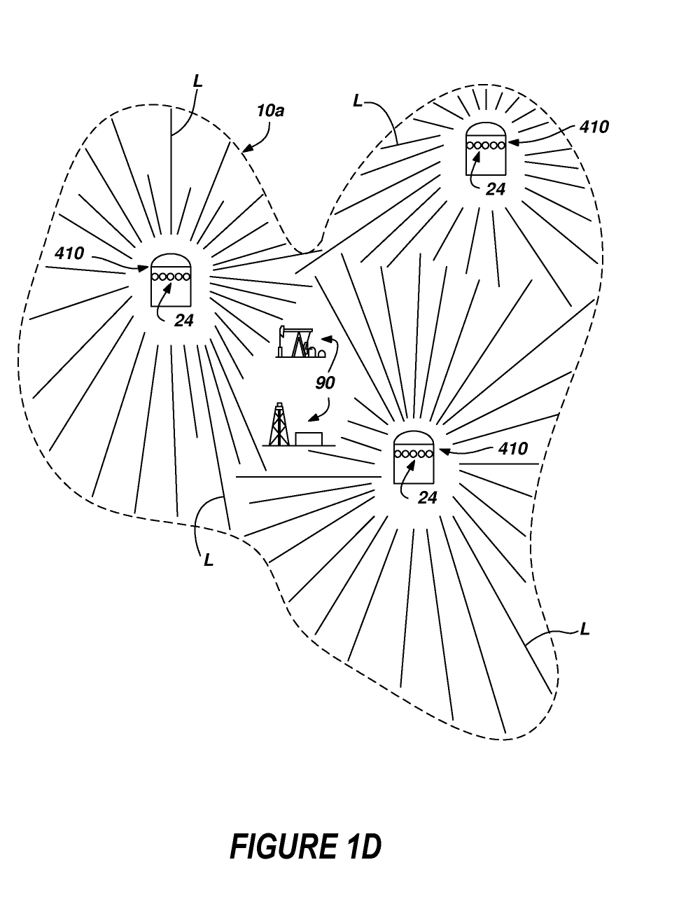

Turning now to the Figures, FIG. 1A depicts an overview of an exemplary monitoring system 11 monitoring multiple hydrocarbon well sites. The system 11 may be used to remotely monitor a plurality of well sites 15a and 15b which may be hydrocarbon well sites. The system may include at least one access tower 410a and 410b at each well site 15a and 15b. The access towers 410a and 410b may be used for remotely monitoring within a geographically defined perimeter of each well site 15a and 15b. Access tower 410a may include an access tower identifier or access tower ID, a tower transceiver 416a (transmitter receiver) and a power supply 412. The tower transceiver 416a may be connected to the power supply 412, a well site processor 20a and a network 16 which may be a communication network for data or signal transmission, for example the Internet, or a wireless communication network. In embodiments, the power supply 412 may comprise a battery, a generator, or combinations thereof. The access towers 410a and 410b may be in communication with an administrative server 103 and a plurality of client devices 32a and 32b via the network 16. The administrative server 103 and the client devices 32a and 32b may be located at the same location or at different locations. The client devices may be located at a remote monitoring station 32 or business building of the associated company.

Access tower 410b may include an access tower identifier or access tower ID, a tower transceiver 416b and a solar panel 600 with batteries 602. The tower transceiver 416b may be connected to the solar panel 600, a well site processor 20b and the network 16. The system may include a plurality of first sensors 24a-24d or perimeter sensors at each well site to sense a first sensed data which may include locations of assets and personnel. Perimeter sensors 24a and 24b may be mounted to the access tower 410a and connected to the power supply 412 and an alarm system 25a. Perimeter sensors 24c and 24d may be mounted to the access tower 410b and connected to the solar panel 600 and an alarm system 25b. The perimeter sensors may be used for detecting and transmitting locations of assets and personnel to the alarm system that arms and disarms alarms for the geographically defined perimeter. The perimeter sensors 24a-24d may be motion sensors or detectors. Examples of motion sensors may be infrared (IR) sensors (passive or reflective), microwave sensors, ultrasonic sensors, acoustic sensors and the like. The system 11 may also be configured to receive identities of the authorized personnel and vehicles to be monitored on the well site from an input device. For example, data including identities of authorized personnel and vehicles arriving at the well site may be inputted to the system 11 using a hand held input device, a smart phone or a laptop computer in connection with the well site data storage via the transceiver and the well site processor that the monitoring system 11 would know the identities of the authorized personnel and vehicles and their location on the well site.

The system may include at least one recording device 28a and 28b at each well site. Recording device 28a may be mounted to the access tower 410a and connected to the power supply 412, well site processor 20a and tower transmitter receiver 416a. Recording device 28b may be mounted to the access tower 410b and connected to the solar panel 600, well site processor 20b and tower transmitter receiver 416b. Each recording device may be used for creating at least one of: videos, infrared images, and audio signals for personnel and assets within the geographically defined perimeter. Recording devices 28a and 28b may be configured to provide a continuous video feed to the client devices 32a and 32b.

The system may include a well site processor 20a and 20b at each well site. Well site processor 20a may be mounted to the access tower 410a. The well site processor 20a may be connected to the power supply 412 and in communication with the tower transceiver 416a, the recording device 28a, and the perimeter sensors 24a and 24b. Well site processor 20b may be mounted to the access tower 410b. The well site processor 20b may be connected to the solar panel 600 and in communication with the tower transmitter receiver 416b, the recording device 28b, and the perimeter sensors 24c and 24d.

The system may include a well site data storage 22a and 22b for each well site. Well site data storage 22a may be in communication with the well site processor 20a. Well site data storage 22b may be in communication with the well site processor 20b. The system 11 may include an administrative processor 100 in communication with an administrative data storage 102. The administrative processor 100 may be connected to the network 16 for receiving an executive dashboard with a tracking map from the well site data storage 22a, 22b and the well site processor 20a, 20b via the tower transceiver. The client devices 32a and 32b may be connected to the administrative processor 100 of the administrative server 103 and the access towers 410a and 410b via the network 16 for remotely monitoring the well sites. Exemplary client devices may be desktop computers, laptop computers, smart phones and the like. The well site data storages 22a, 22b and the administrative data storage 102 may be non-transitory computer readable or usable medium comprising instructions stored thereon which when executed by their respective processors to perform operations or actions. In one embodiment, each access tower may include an access tower housing including an access tower module (see FIG. 1B). The module may include well site processor, wells site data storage, access tower transceiver, alarm system, a GPS module and perimeter sensors. The recording device and the perimeter sensors as well as a wireless communication antenna may be disposed on the access tower housing (see FIG. 1B).

In embodiments, the system can include a plurality of second sensors 29a and 29b or operating sensors to sense a second sensed data including measured operating data of each hydrocarbon well. Operating sensor 29a or operational sensors may be in communication with the well site processor 20a for receiving and transmitting operating data 418a to the well site data storage and for transmission to the account identifier. Operating sensor 29b or operational sensors may be in communication with the well site processor 20b for receiving and transmitting operating data 418b to the well site data storage and for transmission to the account identifier. Operating sensors 29a and 29b may be disposed adjacent or mounted to hydrocarbon wells, hydrocarbon well equipment and related equipment operating within the geographically defined perimeter of each well site 15a and 15b. The operating data may comprise measured values of at least one of: pressures of wellbore fluids, temperatures of wellbore fluids, wellbore fluid levels, load on sucker rod pump, vibration of the access tower, smoke concentration at the well site, carbon monoxide concentration at the well site, hydrogen sulfide concentration at the well site, and water level at the well site.

FIG. 1B and FIG. 1C show an exemplary access tower 410 including a tower housing section 70 and a tower support section 72 including a support rod 72a and a base 72b. The access tower 410 is secured to the ground through a base plate 74 by inserting steel rods, anchoring bolts or anchors into the ground. The solar panel 600 may be attached to the support rod 72a, and the battery 602 may be kept in a sealable compartment within the base 72b. The tower housing section 70 of the access tower may include an access tower module 70a including all the components described above, namely, a plurality of perimeter sensors 24, the alarm system 25, the well site processor 20, the well site data storage 22, and the tower transceiver 416. The recording device 28 may be disposed on top the tower housing to have an uninterrupted 360 degree view. The recording device 28 may have a protective glass or clear polymer cover 76. The tower housing 70 may also include a wireless communication antenna 78. The tower housing 70 may be a cylindrical or polygonal prism shaped housing so that the perimeter sensors 24 may also have a 360 degree uninterrupted view. As shown in FIGS. 1B and 1C, each perimeter sensor 24 may protrude from the circular surface and may be tilted to monitor a preferred direction and area in that direction. The perimeter sensors 24 may be moved vertically, up and down under a tilt angle TA, and also horizontally right to left to cover the desired area or rough terrain within the well site. Sensor guide lines ‘L’ such as L₁ and L₂ in FIG. 1B show where the perimeter sensors may generally be pointed at and under what tilt angle. In this example, a first tilt angle TA₁ between guide line L₁ and the vertical axis VA of the access tower 410 may be less than a second tilt angle TA₂ between the guide line L₂ and the vertical axis VA. Accordingly, under the first tilt angle TA₁ a first location near the access tower 410 may be monitored, and under the second tilt angle TA₂ a second location farther than the first location may be monitored within the well sites. Tilt angles of the perimeter sensors may be adjusted using laser beams from laser pointers 77 or sources as guide lines. Each sensor 24 may have a laser pointer 77 or source attached to the perimeter sensor. Using laser beams, the tilt angle TA of each perimeter sensor 24 on the access tower housing 70 may be individually adjusted to point at a specific location and its surrounding area within the well site to substantially monitor the well site without leaving any unmonitored spot on the well site.

The access tower 410 of the present invention offers a compact, portable, easy to deploy and dismantle, easy to maintain and easy to assemble system. When fully assembled its height may be in the range of 1.75 to 2 meters. The tower housing 70 and the support section 72 can be dismantled by separating connectors sections 73. This way, the access tower housing 70, two pieces of the support section (the support rod 72a and the base 72b) can be quickly separated and placed in a box or a container for transportation. Any malfunctioning access tower can be easily replaced with a new spare one or only the tower housing 70 may be replaced with a new one. This reduces equipment downtime and cost of repairs. The access towers having such features may provide a universal security system especially for a company having many well sites. A hydrocarbon company may use a plurality of access towers of the present invention in many well sites for monitoring and security the well sites.

FIG. 1D shows an exemplary well site 15 surrounded by a geographically defined perimeter 10a. In this embodiment, the well site 15 may be monitored by a plurality of access towers 410 of the present invention. The well site 15 may be protected by three strategically positioned access towers 410 of the present invention. Within the well site there may be at least one hydrocarbon well unit 90 which may have for example a hydrocarbon well and a sucker rod pump, and the like equipment. The hydrocarbon well unit may have the operating sensors 29 (not shown). Operation sensors may detect operation activity of the hydrocarbon well unit components and transmits this data in real time to the access towers 410. The guide lines L for the perimeter sensors define generally the area covered by each perimeter sensor 24, i.e., the area adjacent the line L, and the tilt angle of each perimeter sensor. As explained above, during the installation of the access towers 410, laser guide lines L may be used to accurately define the monitoring coverage area of each perimeter sensor 24 from each access tower 410 so as to substantially cover the well site the within the geographically defined perimeter 10a. In one embodiment this process may define the monitored area map within the geographically defined perimeter. Such laser guide line maps show not only the fully covered well site but also the individual coverage areas of each access tower. Laser guide line distributions of each perimeter sensor and their vertical or horizontal angle adjustment may also be recorded for a future reference for maintenance. For example if an access tower needs to be replaced the same perimeter sensor tilt angle adjustments may be made on the replacement access tower using the replaced access tower's record to cover the same monitoring area. As mentioned above, each access tower 410 includes an access tower ID which may be associated with the GPS position of the access tower 410. The combination of access tower ID and GPS location information may be further associated with the well site ID and GPS location information and/or the hydrocarbon unit ID and location information. Each access tower 410 may have a GPS module. Alternatively, the access towers 410 may be associated with a GPS module of the hydrocarbon well unit 90.

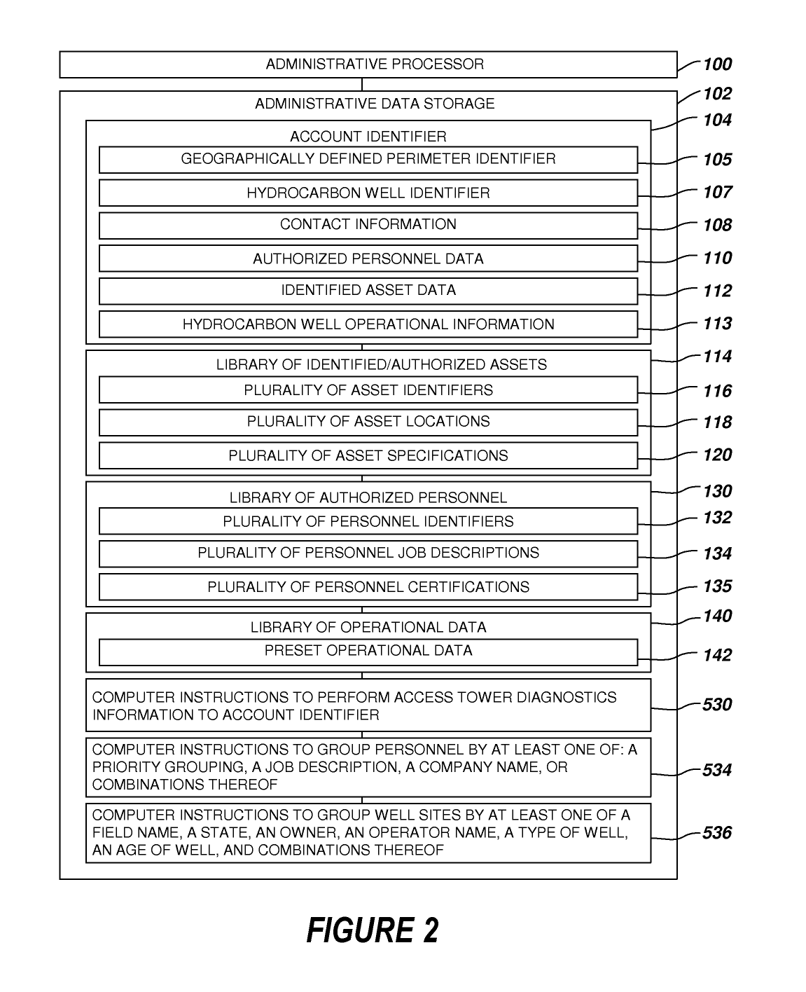

FIG. 2 depicts the administrative processor 100 connected to the administrative data storage 102 of the administrative server 103. The administrative data storage 102 may include an account identifier 104. The account identifier 104 may include data including a geographically defined perimeter identifier 105, a hydrocarbon well identifier 107, contact information 108, authorized personnel data 110 for each hydrocarbon well identifier, identified asset data 112 for each hydrocarbon well identifier, and hydrocarbon well operational information 113 for each hydrocarbon well identifier. The administrative data storage 102 may include a library of identified or authorized assets 114 for each hydrocarbon well identifier associated with the account identifier. The library of identified assets 114 may include a plurality of asset identifiers 116, a plurality of asset locations 118, and a plurality of asset specifications 120. The administrative data storage 102 may include a library of authorized personnel 130 for each hydrocarbon well identifier associated with the account identifier. The library of authorized personnel 130 can include a plurality of personnel identifiers 132, a plurality of personnel job descriptions 134, and a plurality of personnel certifications 135. The administrative data storage 102 may also include a library of operational data 140 for each hydrocarbon well identifier associated with the account identifier. The library of operational data 140 may include a plurality of preset operational values 142 The administrative data storage 102 may include computer instructions 530 to perform access tower diagnostic information and transmit the access tower diagnostic information to the account identifier. The administrative data storage 102 may include computer instructions 534 to group personnel by at least one of: a priority grouping, a job description, a company name, or combinations thereof. The administrative data storage 102 may include computer instructions 536 to group well sites by at least one of: a field name, a state, an owner name, an operator name, a type of well, an age of well, and combinations thereof.

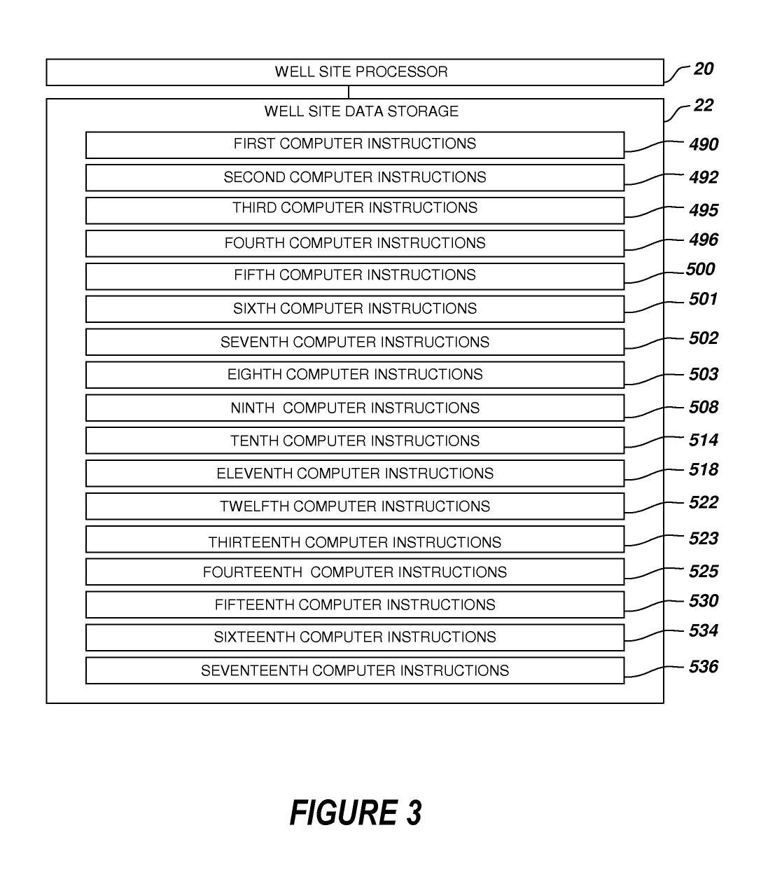

FIG. 3 depicts the well site processor 20 and the well site data storage 22. The well site processor 20 may be connected to the well site data storage 22. The well site data storage 22 may include a plurality of computer instructions. For example, the well site data storage 22 may include first computer instructions 490 to receive detected locations of assets and personnel from the plurality of perimeter sensors. The well site data storage 22 may include second computer instructions 492 to map the detected locations of identified assets and personnel on a geographic map forming a tracking map of the geographically defined perimeter. The well site data storage 22 may include third computer instructions 495 to generate an executive dashboard. The well site data storage 22 may include fourth computer instructions 496 to transmit the executive dashboard with the tracking map to the at least one client device connected to the network. The well site data storage 22 may include fifth computer instructions 500 to receive a command from an administrative data storage in communication with the network to perform an action. The well site data storage 22 may include sixth computer instructions 501 to receive and compare sensed personnel to the library of personnel to authenticate the sensed personnel at each well site for the account identifier. The well site data storage 22 may include seventh computer instructions 502 to receive and compare sensed assets to the library of identified assets to authenticate the sensed assets at each well site for the account identifier. The well site data storage 22 may include eighth computer instructions 503 to arm the geographically defined perimeter. The well site data storage 22 may include ninth computer instructions 508 to disarm the geographically defined perimeter. The well site data storage 22 may include tenth computer instructions 514 to transmit a location of each access tower with the geographically defined perimeter to the account identifier. The well site data storage 22 may include eleventh computer instructions 518 to transmit warning messages that personnel without personnel identifiers are within the geographically defined perimeter to the account identifier.

The well site data storage 22 may include twelfth computer instructions 522 to transmit a timed out perimeter indicator to the account identifier. The well site data storage 22 may include thirteenth computer instructions 523 to receive and compare sensed operational data from each hydrocarbon well to the library of operational data to confirm operational data compliance at each well site for the account identifier. The well site data storage 22 may include fourteenth computer instructions 525 to transmit warning messages to the account identifier when the sensed operational data from one or more hydrocarbon wells is not in compliance with the operational data. The well site data storage 22 may include fifteenth computer instructions 530 to perform access tower diagnostic information and transmit the access tower diagnostic information to the account identifier. The well site data storage 22 may include sixteenth computer instructions 534 to group personnel by at least one of: a priority grouping, a job description, a company name, or combinations thereof. The well site data storage 22 may include seventeenth computer instructions 536 to group well sites by at least one of: a field name, a state, an owner name, an operator name, a type of well, an age of well, and combinations thereof.

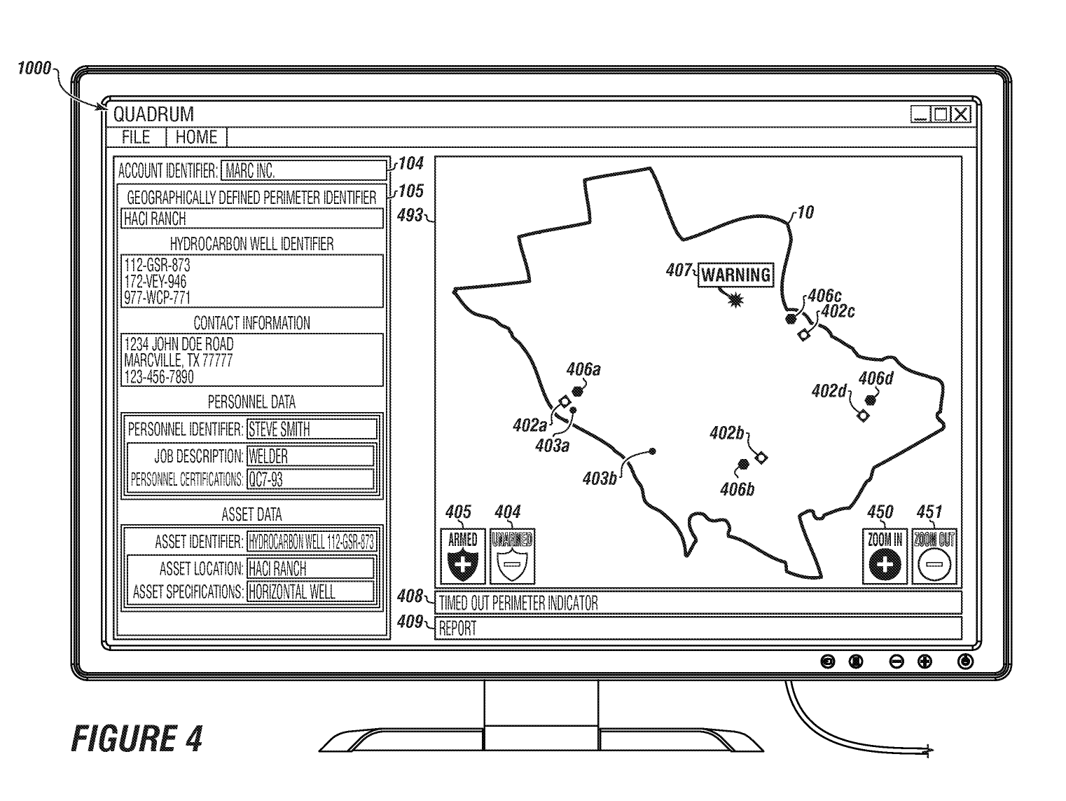

FIG. 4 depicts an executive dashboard created according to an embodiment of the system. The executive dashboard 1000 may display an account identifier 104 with a geographically defined perimeter identifier 105. The executive dashboard 1000 may display a tracking map 493. The executive dashboard 1000 may display asset identifiers 402a-402d, i.e., authorized vehicles or hydrocarbon wells, authorized personnel identifiers 403a and 403b, and locations 406a-406d of access towers within the geographically defined perimeter 10. The executive dashboard 1000 may display an armed perimeter indicator 405 for the geographically defined perimeter 10 for indicating when the alarm system is armed and an unarmed perimeter indicator 404 for the geographically defined perimeter 10 indicating when the alarm system is unarmed. The executive dashboard 1000 may display a zoom in 450 and zoom out 451 buttons to allow the display of a single geographically defined perimeter 10 or a plurality of geographically defined perimeters displayed in the tracking map 493. The executive dashboard 1000 may display warning messages 407 that personnel without personnel identifiers or unauthorized personnel are within the geographically defined perimeter. The executive dashboard 1000 may display warning messages that one of the hydrocarbon wells is operating beyond preset operational limits. The executive dashboard 1000 may display a video feed from the recording device to monitor the geographically defined perimeter. The executive dashboard 1000 may display a timed out perimeter indicator 408 indicating the alarm system was left unarmed in excess of a preset limit of time. The executive dashboard 1000 may also display a report 409.

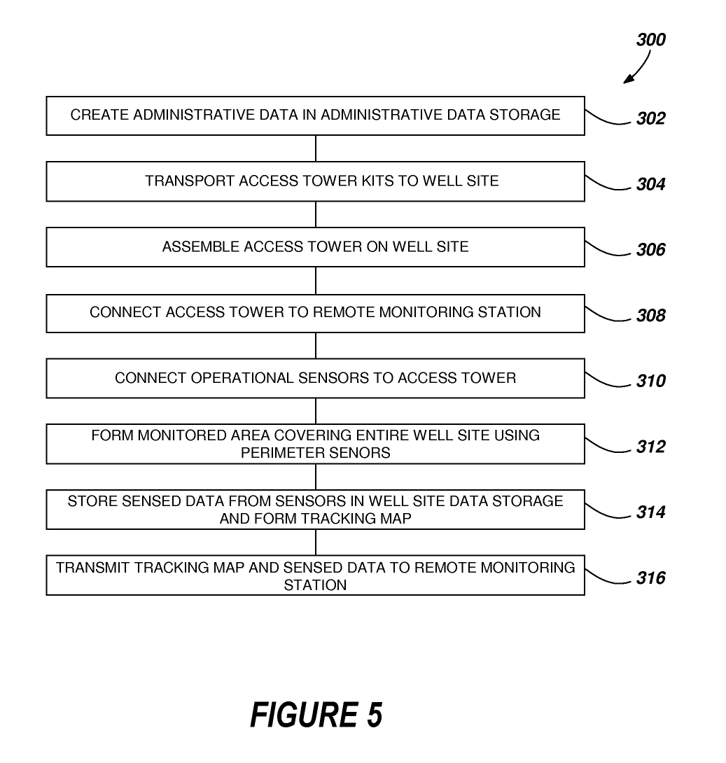

FIG. 5 shows a flow chart 300 for an embodiment of an exemplary process for monitoring hydrocarbon well sites using the system 11. Referring to FIGS. 1A-5, in process step 302 an administrative data may be created and stored in the administrative data storage 102 of the administrative server 103. In process step 304 an access tower kit including the components of an access tower 410 including a tower housing 70 and a tower support section 72, may be transported to the well site 15. In process step 306, the access tower 410 is assembled by connecting the tower housing 70 to the support section 72 and then the access tower is installed on the well site ground. In process step 308, the access tower 410 is powered and wirelessly connected to the remote monitoring station 32 and the administrative server 103 via the network 16. In operation step 310, the operational sensors 29 on the hydrocarbon well equipment are connected to the access tower 410 for monitoring the operation of the hydrocarbon well equipment. In process step 312, using the perimeter sensors 24, a monitored area covering the entire well site within the geographically defined perimeter may be formed.

At this stage, as the perimeter sensors 24 are monitoring the well site, the alarm system 25 may be armed. When the alarm system 25 is armed, if an activity detected within the well site 15 by the perimeter sensors 24, the alarm system may sound sirens and warning messages indicating the activity may be sent to the remote monitoring station 32 or the client devices 32a and 32b. When the alarm system is disarmed to allow authorized personnel and authorized vehicles to enter the well site 15, the perimeter sensors may monitor the activity of authorized personnel and vehicles and their location. In one embodiment, prior to disarming the alarm system, by employing an input device identity and other information of the authorized personnel and vehicles, which are about to enter the well site, is transmitted to the access tower 410 and stored in the well site data storage 22. In operation step 314, the sensed data from the perimeter sensors 24 and the operational sensors 29 is stored in real time in the well site data storage and a tracking map is formed in real time using the sensed data. The tracking map may include results of the comparison between the sensed data from the sensors 24, 29 stored in the well site data storage and the stored data in the administrative storage. In process step 316, the tracking map and sensed data are transmitted in real time to the client devices.

Although aspects and advantages of the present invention are described herein with respect to certain preferred embodiments, modifications of the preferred embodiments will be apparent to those skilled in the art. Thus the scope of the present invention should not be limited to the foregoing discussion, but should be defined by the appended claims.

What is claimed is:

1. An automated system for remotely monitoring, location mapping, and transmitting to at least one client device via a network, maps, asset information, operational and personnel information on assets including information on at least one hydrocarbon well and personnel within a geographically defined perimeter of at least one well site including information on movement of those assets and personnel, comprising:
a plurality of operating sensors disposed adjacent the at least one hydrocarbon well and configured to detect and transmit operating data of each hydrocarbon well;
at least one access tower positioned at each well site for remotely monitoring within the geographically defined perimeter, each access tower comprising:
an access tower identifier,
an alarm system for arming and disarming alarms for the geographically defined perimeter,
a power supply mounted to the access tower,
a tower transceiver connected to the power supply,
a well site processor mounted to the access tower and in communication with the tower transceiver and electrically connected to the power supply,
a plurality of perimeter sensors, in communication with the well site processor, mounted to the access tower and configured to detect and transmit locations of assets and personnel, the plurality of perimeter sensors being connected to the power supply and the alarm system for arming and disarming alarms for the geographically defined perimeter,
a well site data storage, including non-transitory computer readable medium, in communication with the well site processor, the well site storage being configured to receive the locations of personnel and assets from the plurality of perimeter sensors as well as the operating data of each hydrocarbon well from the plurality of operating sensors, wherein the well site data storage is configured to form a tracking map and an executive dashboard including the tracking map showing the locations of personnel and assets as well as the operating data of each hydrocarbon well from the plurality of operating sensors, and
at least one recording device mounted to the access tower and electrically connected to the power supply for creating at least one of videos, infrared images, and audio signals for personnel and assets within the geographically defined perimeter for each well site;
an administrative processor connected, via the network, to both the transceiver at each access tower and at least one client device for remotely monitoring each well site; and
an administrative data storage, including non-transitory computer readable medium, in communication with the administrative processor for receiving the executive dashboard with the tracking map from the well site data storage, the administrative data storage comprising an account identifier with the hydrocarbon well identifier, contact information, personnel data for each hydrocarbon well identifier, and asset data for each hydrocarbon well identifier.

2. The system of claim 1, wherein the administrative data storage further comprising:
a library of identified assets for each hydrocarbon well identifier associated with the account identifier, the library of identified assets comprising:
a plurality of asset identifiers;
a plurality of asset locations; and
a plurality of asset specifications;
a library of personnel for each hydrocarbon well identifier associated with the account identifier, the library of personnel comprising:
a plurality of personnel identifiers;
a plurality of personnel job descriptions; and
a plurality of personnel certifications.

3. The system of claim 2, wherein the well site data storage further comprising:
computer instructions to receive detected locations of assets and personnel from the plurality of perimeter sensors;
computer instructions to map the detected locations of assets and personnel on a geographic map forming the tracking map of the geographically defined perimeter;
computer instructions to generate the executive dashboard;
computer instructions to transmit the executive dashboard with the tracking map to each client device connected to the network;
computer instructions to receive a command from the administrative data storage in communication with the network to perform an action;
computer instructions to receive and compare sensed personnel to the library of personnel to authenticate the sensed personnel at each well site for the account identifier;
computer instructions to receive and compare sensed assets to the library of identified assets to authenticate the sensed assets at each well site for the account identifier;
computer instructions to arm the geographically defined perimeter;
computer instructions to disarm the geographically defined perimeter;
computer instructions to transmit a location of each access tower with the geographically defined perimeter to the account identifier;
computer instructions to transmit warning messages that personnel without personnel identifiers are within the geographically defined perimeter to the account identifier; and
computer instructions to transmit a timed out perimeter indicator to the account identifier;

4. The system of claim 3, wherein the executive dashboard further displays at least one of:
an account identifier with a geographically defined perimeter identifier;
asset identifiers within the geographically defined perimeter;
personnel identifiers of personnel within the geographically defined perimeter;
locations of access towers within the geographically defined perimeter;
the tracking map;
an armed perimeter indicator for the geographically defined perimeter indicating when the alarm system is armed;
an unarmed perimeter indicator for the geographically defined perimeter indicating when the alarm system is unarmed;
warning messages that personnel without personnel identifiers are within the geographically defined perimeter;
a timed out perimeter indicator indicating the alarm system was left unarmed in excess of a preset limit of time; and
a report;

5. The system of claim 4, wherein the operating data comprises at least one of:
pressures of wellbore fluids;
temperatures of wellbore fluids;
wellbore fluid levels;
a load on sucker rod pump;
a vibration of the access tower;
a smoke concentration at the well site;
a carbon monoxide concentration at the well site;
a hydrogen sulfide concentration at the well site; and
a water level at the well site.

6. The system of claim 3 further comprising computer instructions in the administrative data storage and in the well site data storage to perform access tower diagnostic information and transmit the access tower diagnostic information to the account identifier.

7. The system of claim 3 further comprising computer instructions in the administrative data storage and in the well site data storage to group personnel by at least one of: a priority grouping, a job description, a company name, or combinations thereof.

8. The system of claim 3 further comprising computer instructions in the administrative data storage and in the well site data storage to group well sites by at least one of: a field name, a state, an owner name, an operator name, a type of well, an age of well, and combinations thereof.

9. The system of claim 1, wherein the power supply is a solar panel connected to batteries.

10. The system of claim 1, wherein the power supply comprises a battery, a generator, or both the battery and the generator.

11. The system of claim 1, wherein the perimeter sensors are motion sensors.

12. A method of remotely monitoring a hydrocarbon well site having a geographically defined perimeter, comprising:
creating an administrative data in an administrative data storage to the hydrocarbon well site, the administrative data storage includes non-transitory computer readable medium, comprising:
assigning personal identifications to authorized persons, the authorized persons being permitted to access to the hydrocarbon well site,
associating each authorized person to a selected work location at the hydrocarbon well site,
assigning asset identifications to identified assets at the hydrocarbon well site, the identified assets including authorized vehicles permitted to access to the hydrocarbon well site and at least one hydrocarbon well located at the hydrocarbon well site, and
identifying operation parameters associated with at least one hydrocarbon well located at the hydrocarbon well site;
identifying an access tower within the hydrocarbon well site;
continuously capturing a video and audio recording of the hydrocarbon well site using a camera recorder mounted to the access tower;
receiving in real time a first sensed data from a first set of sensors mounted on the access tower, the first sensed data from the first set of sensors including locations of the authorized persons within the hydrocarbon well site and locations of the authorized vehicles within the hydrocarbon well site;
receiving in real time a second sensed data from a second set of sensors located at each hydrocarbon well, the second sensed data including identification of each hydrocarbon well and the operational data associated with each hydrocarbon well, wherein the operational data include data associated with a plurality of operational measurements generated by control devices of each hydrocarbon well;
storing a well site data record of the hydrocarbon well site in a well site data storage located at the access tower, the well site data record including the first sensed data and the second sensed data, wherein the well site data storage includes non-transitory computer readable medium;
forming an electronic map of the hydrocarbon well site using the well site record and mapping the locations of the authorized persons on the electronic map of the hydrocarbon well site; and
electronically communicating the electronic map as well as the video and audio recording of the well site to a monitoring location remote to the hydrocarbon well site so as to remotely monitor the well site.

13. The method of claim 12 further comprising receiving a third sensed data from a first set of sensors, the third sensed data including location of unauthorized persons, unauthorized vehicles and animals.

14. The method of claim 13 further comprising storing the identity of the authorized persons and the authorized vehicles in the well site data storage prior to the step of receiving in real time a first sensed data from a first set of sensors.

15. The method of claim 14 further comprising protecting the well site with an alarm system in communication with the first set of sensors, the alarm system is configured to arm and disarm the geographically defined perimeter.

16. The method of claim 15 further comprising comparing identity of the authorized persons in the first sensed data to the personnel identifications stored in the administrative data base to authenticate the identification of authorized persons.

17. The method of claim 16 further comprising:
generating a warning if a variance between the personal identifications stored in the administrative data base and the identifications of the authorized persons included in the first sensed data exists; and
transmitting the warning to the monitoring location.

18. The method of claim 15 further comprising comparing the identity of the authorized vehicles in the first sensed data to the asset identifications stored in the administrative data base to authenticate the identification of authorized vehicles.

19. The method of claim 18 further comprising:
generating a warning if a variance between the asset identifications stored in the administrative data base and the identifications of the authorized vehicles included in the first sensed data exists; and
transmitting the warning to the monitoring location.

20. The method of claim 15 further comprising comparing the second sensed data from the first set of sensors to the operation parameters associated with at least one hydrocarbon well to maintain an operation of the hydrocarbon well within compliance limits.

21. The method of claim 20 further comprising:
generating a warning if the operation data from the hydrocarbon well is outside the compliance limits; and
transmitting the warning to the monitoring location.

22. The method of claim 12, wherein the access tower includes:
a well site processor in communication with the first set of sensors and the second set of sensors;
a well site data base in communication with the well site processor;
a transceiver in communication with the well site processor as well as the first set of sensors and the second set of sensors, the transceiver being connected to a wireless communication network to transmit data from and receive data for the access tower; and
at least one power supply supplying power to the well site processor, the first set of sensors and the second set of sensors as well as the transceiver.

23. The method of claim 22, wherein the at least one power supply includes a solar power supply.

24. The method of claim 23, wherein the transceiver is in communication with an administrative processor in communication with the administrative database.

25. A method of monitoring a hydrocarbon well site having a geographically defined perimeter, the well site including at least one hydrocarbon well unit, comprising:
transporting at least one access tower to the well site, each access tower being transported as a kit wherein each kit includes a tower base, a tower support and a tower housing including a plurality of motion sensors connected to an access tower module;
assembling each access tower by attaching the tower housing to a first end of the tower support and by attaching the base to a second end of the support, and anchoring the base to the ground within the well site;
adjusting, using a plurality of laser beams as guide, direction and effective distance of the plurality of motion sensors of each access tower to form a monitored area covering the well site, wherein each motion sensor is activated when a motion is detected within the motion sensor's effective distance;
recording direction and effective distance of each motion sensor on each access tower to prepare a replacement access tower to replace a malfunctioning access tower quickly;
connecting each motion sensor to an alarm system in each module, each alarm system being configured to arm and disarm the monitored area, wherein alarm system is activated when at least one of the motion sensors is activated on the access tower; and
connecting each access tower module to a remote monitoring station to remotely monitor the well site.

26. The method of claim 25 further comprising connecting a plurality of operational sensors disposed in each hydrocarbon unit to the access tower module adjacent the hydrocarbon unit so as to monitor the operation of the hydrocarbon unit.

27. The method of claim 26, wherein the access tower module further comprising:
a processor in communication with the motion sensors and the operational sensors;
a data base in communication with the processor;
a GPS module; and
a transceiver in communication with the processor as well as the operational sensors, the transceiver being connected to a wireless communication network to transmit data to the remote monitoring station and receive data from the monitoring station.

28. The method of claim 27 further comprising a power supply supplying power to the access tower module.

29. The method of claim 28 wherein power supply includes a solar panel.

30. The method of claim 25 further comprising continuously capturing a video and audio recording of the hydrocarbon well site using a camera recorder mounted to the access tower housing.
